(19) United States
(12) Patent Application Publication
(10) Pub. No.: US 2002/0161654 A1
(43) Pub. Date: Oct. 31, 2002

(54) Information processing apparatus and method for managing order/delivery of components

(75) Inventors: Toshio Uetake, Ibaraki (JP); Sadao Ito, Ibaraki (JP); Yoshihito Nakayama, Ibaraki (JP); Fujio Someya, Ibaraki (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/119,001

(22) Filed: Apr. 10, 2002

(30) Foreign Application Priority Data
Apr. 25, 2001 (JP) 127764/2001
Feb. 5, 2002 (JP) 028157/2002

(51) Int. Cl. G06F 17/60

(52) U.S. Cl. 705/22; 705/28

(57) ABSTRACT

A production management system transfers information, such as preliminary information relating to an order, to a material procurement system. An assembly maker changes a production plan of units from a terminal by referring to this information. Information on which the change is reflected is opened so as to be referred to from a component maker. The component maker produces components based on the referred information, and deposits the produced components in a deposit warehouse. The assembly maker produces each assembled component using components delivered from the deposit warehouse, and delivers produced assembled components to a product developing/manufacturing company.

### BACKGROUND OF THE INVENTION

1. Field of the Invention

The present invention relates to an information processing apparatus and method, and more particularly, to an information processing apparatus and method for managing order/delivery of components.

2. Description of the Related Art

Conventionally, when an enterprise manufactures a product, components used for the product are ordered, and production is performed after delivery of the components. In addition to delivery of components, the frequency of delivery of assembled components, each obtained by assembling a plurality of components, is increasing. However, in order to realize delivery of components when they are required for production, it is necessary to request production of the components in advance. The situation is the same for components used for an assembled component. Furthermore, management of components to be used is performed at each of a plurality of production centers.

Accordingly, production is estimated in advance, and there is a tendency to order a larger number of components than actually required. Furthermore, since components for an assembled component are ordered independently by the maker of the assembled component, delivery of the assembled component tends to be delayed. Therefore, it is necessary to plan production earlier.

Furthermore, since components are managed at each production center, surplus/shortage of components tends to occur at each production center. Therefore, it is necessary to perform efficient management.

### SUMMARY OF THE INVENTION

The present invention has been made in consideration of the above-described problems.

It is an object of the present invention to provide an information processing apparatus and method for shortening the period from order to delivery of components.

It is another object of the present invention to provide an information processing apparatus and method for improving management efficiency from order to delivery of components.

It is still another object of the present invention to provide an information processing apparatus and method for reducing variations in production of components in a component maker.

According to one aspect of the present invention, an information processing apparatus includes plan reference means for making a production plan in a state capable of being referred to from a unit maker, reception means for receiving a production plan from the unit maker, calculation means for obtaining an amount of demand of each type of component of a product based on the production plan from the unit maker and information relating to a configuration of the product, and demand reference means for generating the obtained amount of demand into a state capable of being referenced by a component maker.

According to another aspect of the present invention, an information processing apparatus includes reference means for referring to demand information from a client, delivery means for delivering each type of component produced based on the demand information to an assigned destination different from the client, confirmation means for confirming information relating to delivery acceptance of each type of component based on information from the destination, and request means for requesting a cost for each type of component from the client, based on the confirmed information.

According to still another aspect of the present invention, an information processing apparatus in a producer for delivering each type of assembled component to a client includes plan means for providing a production plan of each type of assembled component based on information from the client, transfer means for transferring information based on the production plan to the client, payment means for paying a cost for each type of component from a component maker different from the client, to the client, and request means for requesting a cost for each type of assembled component from the client.

According to yet another aspect of the present invention, an information processing method includes a plan reference step of generating a production plan in a state capable of being referred to from a unit maker, a reception step of receiving a production plan from the unit maker, a calculation step of obtaining an amount of demand of each type of component of a product based on the production plan and information relating to a configuration of the product, and a demand reference step of generating the obtained amount of demand into a state capable of being referenced by a component maker.

According to yet a further aspect of the present invention, an information processing method includes a reference step of referring to demand information from a client, a delivery step of delivering each type of component produced based on the demand information to an assigned destination different from the client, a confirmation step of confirming information relating to delivery acceptance of each type of component based on information from the client, and a request step of requesting a cost for each type of component from the client, based on the confirmed information.

According to still another aspect of the present invention, an information processing method in a maker for delivering each type of assembled component to a client includes a plan step of providing a production plan of each type of assembled component based on information from the client, a transfer step of transferring information based on the production plan to the client, a payment step of paying a cost for each type of component from a component maker different from the client, to the client, and a request step of requesting a cost for each type of assembled component from the client.

According to still another aspect of the present invention, an information processing apparatus sharing information relating to production in a product maker, an assembly maker and a component maker includes summary display means for displaying a summary of an input plan of assembled components in the product maker, change means for instructing a change of the input plan displayed on the summary display means, and order-information display means for displaying information relating to an order of components including components to be used in the assembled components on an terminal of the component maker, based on the change.

According to still another aspect of the present invention, an information processing method sharing information relating to production in a product manufacturer, an assembly manufacturer and a component manufacturer includes a summary display step of displaying a summary of an input plan of assembled components in the product manufacturer, a change step of instructing a change of the input plan displayed in the summary display step, and an order-information display step of displaying information relating to order of components including components to be used in the assembled components on a terminal of the component manufacturer, based on the change.

The foregoing and other objects, advantages and features of the present invention will become more apparent from the following detailed description of the preferred embodiment in conjunction with the accompanying drawings.

### BRIEF DESCRIPTION OF THE DRAWINGS

FIG. 1 is a block diagram illustrating the entire system of an information processing apparatus according to an embodiment of the present invention;

FIG. 2 is a diagram illustrating the concept of flow of information and components in the embodiment;

FIG. 3 is a block diagram illustrating a computer for realizing a production control system and a material procurement system, or a computer for realizing respective terminals;

FIG. 4 is a diagram illustrating an initial picture frame of the system;

FIG. 5 is a diagram illustrating a picture frame for registering a target parent item;

FIG. 6 is a diagram illustrating a picture frame for inputting a supplier code of the target parent item;

FIG. 7 is a diagram illustrating a picture frame for assigning extraction conditions of the target parent item;

FIG. 8 is a diagram illustrating a picture frame for displaying a summary table of target parent items;

FIG. 9 is a diagram illustrating a picture frame for displaying details of a target parent item;

FIG. 10 is a diagram illustrating a picture frame for assigning extraction conditions as sourcing term of a child item;

FIG. 11 is a diagram illustrating a picture frame for displaying a summary of conditions as sourcing term of child items;

FIG. 12 is a diagram illustrating a picture frame for displaying details of sourcing term of a child item;

FIG. 13 is a diagram illustrating a picture frame for inputting a supplier code for an input plan of a parent item;

FIG. 14 is a diagram illustrating a picture frame for assigning extraction conditions of the input plan of the parent item;

FIGS. 15 and 16 are diagrams, each illustrating a picture frame for displaying a summary of input plans of parent items;

FIG. 17 is a diagram illustrating a picture frame for inputting a supplier code in case of a price being unset;

FIG. 18 is a diagram illustrating a picture frame for assigning extraction conditions in case of a price being unset;

FIG. 19 is a diagram illustrating a picture frame for displaying a summary when a price is unset;

FIG. 20 is a diagram illustrating a picture frame for displaying details in case of a price being unset;

FIG. 21 is a diagram illustrating a picture frame for assigning extraction conditions when approving a price;

FIG. 22 is a diagram illustrating a picture frame for displaying a summary when approving a price;

FIG. 23 is a diagram illustrating a picture frame for displaying details when approving a price;

FIG. 24 is a diagram illustrating a picture frame for inputting a supplier code when watching PO status of a parent item;

FIG. 25 is a diagram illustrating a picture frame for assigning extraction conditions when accepting an order of a parent item;

FIG. 26 is a diagram illustrating a picture frame for displaying a summary of PO status of parent items;

FIG. 27 is a diagram illustrating a picture frame for displaying details of order acceptance of a parent item;

FIG. 28 is a diagram illustrating a picture frame for inputting a supplier code for an order for a child item;

FIG. 29 is a diagram illustrating a picture frame for assigning extraction conditions for an order for a child item;

FIG. 30 is a diagram illustrating a picture frame for displaying a summary table of order acceptance of child items;

FIG. 31 is a diagram illustrating a picture frame for displaying details of an order for a child item;

FIG. 32 is a diagram illustrating a picture frame for displaying an additional order for a child item;

FIG. 33 is a diagram illustrating a picture frame for displaying updating of an order for a child item; and

FIG. 34 is a diagram illustrating a picture frame for displaying cancellation of PO for a child item.

### DETAILED DESCRIPTION OF THE PREFERRED EMBODIMENT

A preferred embodiment of the present invention will now be described in detail with reference to the drawings.

Entire Configuration of a System

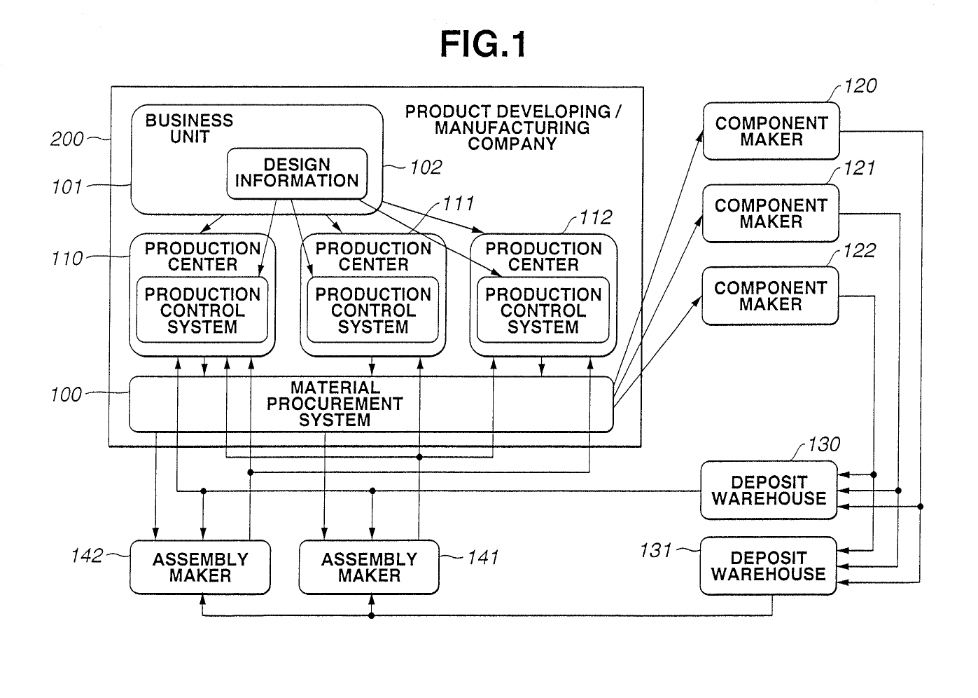

FIG. 1 is a block diagram illustrating an example of the entire system of an information processing apparatus according to the embodiment. In FIG. 1, reference numeral 200 represents a product developing/manufacturing company, which includes a business unit 101, and production centers 110-112. Reference numeral 100 represents a material procurement system. The material procurement system 100 is realized by operating an ordinary computer with a program for realizing processing for this system. The situation is the same for each of the following configurations.

The business unit 101 performs, for example, design of products, and in this embodiment, a sales plan of each product. The business unit 101 has design-information data 102. The design-information data 102 and the sales plan are transmitted to the production centers 110-112. The design-information data 102 includes at least components and assembled components required for each type of product, and the quantity of each type of component and assembled component.

Each of the production centers 110-112 prepares a production plan based on the sales plan, forms process information based on the design-information data 102, and transmits this set of information to the material procurement system 100.

The material procurement system 100 obtains information relating to necessary components (information relating to the necessary quantity, due date, the destination and the like of each type of component) based on the process information, configuration information and the production plan, so as to allow a terminal of each of component makers 120-122 to refer to the information.

Each of the component makers 120-122 prepares a production plan based on the referred information, manufactures components based on the prepared plan, and deposits the manufactured components in assigned ones of deposit warehouses 130 and 131.

Components are appropriately delivered from the deposit warehouses 130 and 131 to assembly makers 141 and 142 and the production centers 110-112, based on information from the material procurement system 100.

The material procurement system 100 can refer to, in advance, information relating to production from the terminal of each of the assembly makers 141 and 142. Assembled components are produced using the delivered components, and are delivered to the production centers 110-112 of products.

The production centers 110-112 manufacture products using assembled components (hereinafter also termed “units”) from the assembly makers 141 and 142, and components from the deposit warehouses 130 and 131, and ship the manufactured products out. Flow of information and components

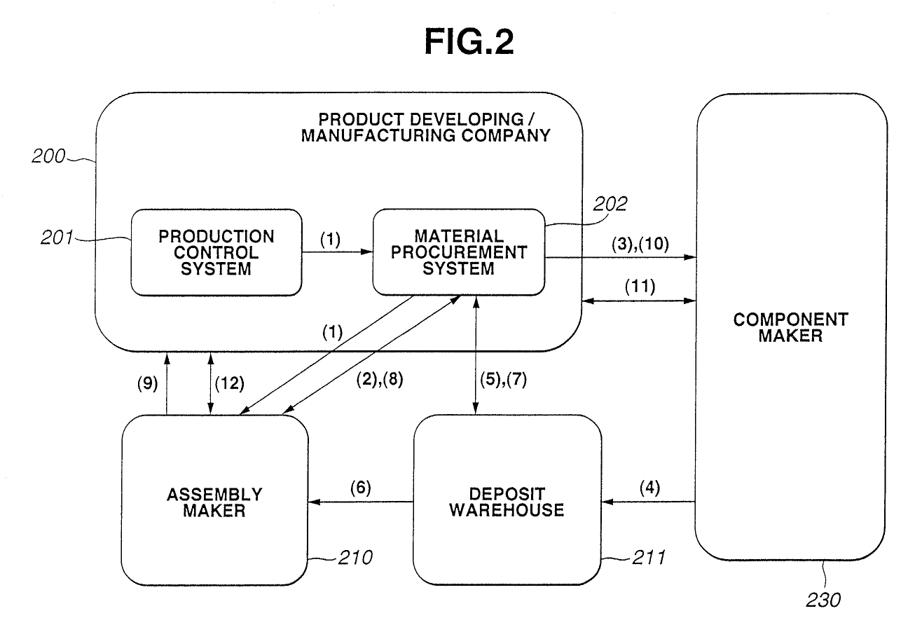

Next, the flow of information and components in the embodiment will be described in detail with reference to FIG. 2.

FIG. 2 is a diagram illustrating an example of the flow of information and components in the embodiment. In FIG. 2, a material procurement system 202 is assumed to be present in a material-procurement-system management unit, but may also be present in one of production centers 110-112 or in the business unit 101. A production control system 201 generally controls production activities of the production centers in order to efficiently operate resources (labor, mechanical equipment, materials and the like) of each of the production centers (factories) so that a determined number of products having constant quality are manufactured before a predetermined time period at each of the production centers.

The material procurement system 202 performs a series of procurement/physical distribution operations including quotation, instructions of deposit, order/order acceptance, physical distribution and payment, via a network, such as the Internet or the like. Particularly, the material procurement system 202 has the ability to be referenced from the terminal of each of the assembly makers and the component makers, and a data transmission/reception function. The material procurement system 202 also has, of course, a security function.

An assembly maker 210 produces and delivers assembled components for the product developing/manufacturing company 200. A deposit warehouse 211 deposits components from a component maker 230, and ships the deposited components to the assembly maker 210. In this embodiment, an external management company (not shown) manages the deposit warehouse 210. The component maker 230 ships produced components out to the deposit warehouse 211 based on an instruction of deposit from the product developing/manufacturing company 200.

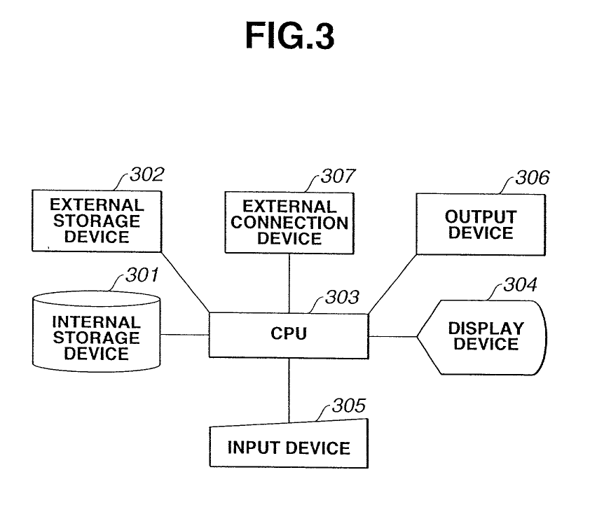

FIG. 3 is a block diagram illustrating a computer for realizing the production control system 201 and the material procurement system 202, or a computer for realizing respective terminals. These computers have different functions depending on programs to be executed and are realized by the same configuration. However, these computers may have different configurations.

In FIG. 3, an internal storage device 301 comprises a semiconductor storage device, such as a RAM (random access memory) or the like, for storing various data (to be described later), and programs for realizing the embodiment. An external storage device 302 comprises a magnetic storage device or the like. A CPU (central processing unit) 303 executes processing in response to commands of each program for realizing the functions of each device. A display device 304 displays an input picture frame and an output picture frame in accordance with a command from the CPU 303. An input device 305 comprises, for example, a mouse or a keyboard for providing an instruction to a program. An output device 306 comprises a printer, for example, for outputting information in accordance with a command from the CPU 303. An external connection device 307 connects the management system to an external apparatus, to supply the external apparatus with data from the system and control the system from the external apparatus.

Referring again to FIG. 2, the production control system 201 transfers processing flow information, configuration information, information relating to order acceptance or an order, and preliminary information relating to the order, of each type of product, to the material procurement system 202, based on production plans provided by the production centers 110-112. Such information can also be retrieved by the terminal of the assembly maker 210 (as indicated by reference numeral (1) in FIG. 2, which will be hereinafter merely indicated by (1). The situation is the same for other cases.). The assembly maker 210 can change information, such as the operation sheet, the configuration or the like, relating a unit (an assembled component), as well as the production plan of the unit for the material procurement system 202, based on the preliminary information relating to the order ((2)).

The material procurement system 202 obtains a required quantity of each type of component to be ordered for the component maker 230 for every location of use, based on the changed information from the production control system 201 and the assembly maker 210, and forms demand forecast and an instruction of deposit based on the accumulated required quantity, so as to be able to be referred to from the component maker 230 ((3)). At that time, information for assigning a destination of each type of component can also be simultaneously referred to.

The component maker 230 provides a production plan based on the referred demand forecast, produces components, and deposits the produced components in the assigned deposit warehouse 211 ((4)). Although this production based on demand forecast is not based on a formal order, the component maker 230 can perform production based on demand forecast if the product developing/manufacturing company guarantees manufacture of the concerned products. This demand forecast is performed periodically (for example, once per month, week or day) or randomly. When performing demand forecast randomly, the assembly maker 210 and the component maker 230 are notified of such.

In this embodiment, management of delivery (whether or not the concerned components have arrived at the deposit warehouse) for the demand forecast is performed by an owner or a procurement consignment unit (not shown). The material procurement system 202 can know the state of components by seeing data of a management company via a network. Then, a confirmed order (an instruction for shipment from the deposit warehouse 211) is transferred from the material procurement system 202 to the component maker 230 and the deposit warehouse 211 (management company) ((5)). The management company performs processing of providing a bill, and an invoice, serving as accounts, of transacted goods, and delivers components from the deposit warehouse 211 to the assembly maker 210 ((6)). Information relating to the delivery is transferred from the management company to the material procurement system 202 ((7)).

The assembly maker 210 performs delivery acceptance of the received components, and transmits information relating to the delivery acceptance from the terminal of the assembly maker 210 to the material procurement system 202 ((8)). The component maker 230 can confirm delivery-acceptance information by seeing the information from the material procurement system 202 via the network. The assembly maker 210 produces assembled components based on the plan, and delivers the produced assembled components to the product developing/manufacturing company 200 ((9)). The product developing/manufacturing company 200 produces products using these assembled components.

The material procurement system 202 formulates the results of delivery acceptance for each month for each component maker instead of payment lists, so that the component maker 230 can refer to this information through the terminal of the component maker 230 ((10)). The component maker 230 forms bills based on the results of delivery acceptance, and transmits the bills to the product developing/manufacturing company 200. The product developing/manufacturing company 200 collates these bills with the bills and the invoices of the transacted goods, and pays the costs of the components to the component maker 230 ((11)).

The product developing/manufacturing company 200 requests the costs of the components from the assembly maker 210, which pays the costs of the components to the product developing/manufacturing company 200 ((12)). In addition, the product developing/manufacturing company pays the billed costs of the assembled components to the assembly maker 210.

(Order-Destination Master File)

An order-destination master file is a master file for managing the above-described component makers and assembly makers. This master file is stored in the storage device within the material procurement system 202.

Management items of this file include, for example:

a supplier code indicating a component maker or an assembly maker (a connection), represented by a four-digit code;

a factory code for identifying one of a plurality of factories having the same supplier code, represented by a two-digit code;

the name of a factory of the connection, represented by a maximum 40-digit text; and

a location of the factory of the connection, represented by a maximum 100-digit text.

(Delivery-Destination Master File)

A delivery-destination master file is a master file for managing a location of delivery, such as the above-described management company (deposit warehouse), an assembly maker, a production center or the like. This file is stored in the storage device within the material procurement system 202.

Management items of this file include, for example:

a delivery-location code indicating a receiving location where subcontractor receives components from a supplier or deposit warehouse (a delivery location), represented by a four-digit code;

a supplier code indicating a connection, represented by a four-digit code (the same code as the above-described connection code of the order destination is used);

the name of the supplier, represented by a maximum 40-digit text; and

a supplier-factory code for identifying one of a plurality of factories of the same supplier code, represented by a two-digit code (the same code as the above-described factory code of the factory of the destination of the order is used).

(Assigned-Unit File)

This is a file for managing a unit subjected to consignment of processing to a target supplier (an assembly maker). This file is stored in the storage device within the material procurement system 202.

Management items include, for example,:

a supplier code indicating a supplier, represented by a four-digit code (the same code as the above-described connection code of the order destination is used);

a factory code for identifying one of a plurality of factories of each supplier, represented by a two-digit code (the same code as the above-described supplier-factory code of the destination of the order is used); and

a unit number indicating a unit to be subjected to consignment of processing, represented by a maximum 20-digit code.

(Design-information File)

This is a file indicating components used for a product. This file is formed based on CAD (computer aided design) from a design unit, and is stored in the storage device within the material procurement system 202.

The following items are stored for each product (number):

the number (hereinafter termed a “unit number”), and the quantity to be produced of each type of assembled component, and components required for each type of assembled component and the quantity to be produced of each type of component; and

components other than the assembled components, the quantity to be produced of each type of such component, and the like.

(Calendar File)

This is a file indicating the product developing/manufacturing company 200, production centers of the company 200, work days of each component maker and assembly maker, and the like. This file is stored in the storage device within the material procurement system 202.

Operation Picture Frame in this System

Operation picture frames in this system will now be described.

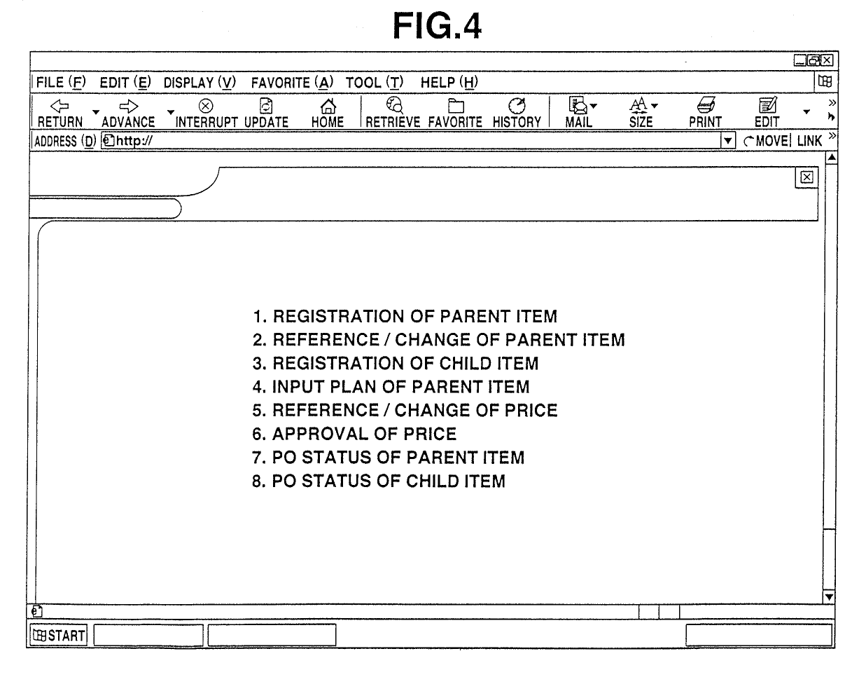

First, an initial picture frame shown in FIG. 4 is displayed on the display picture surface of the system.

(Registration of a Parent Item)

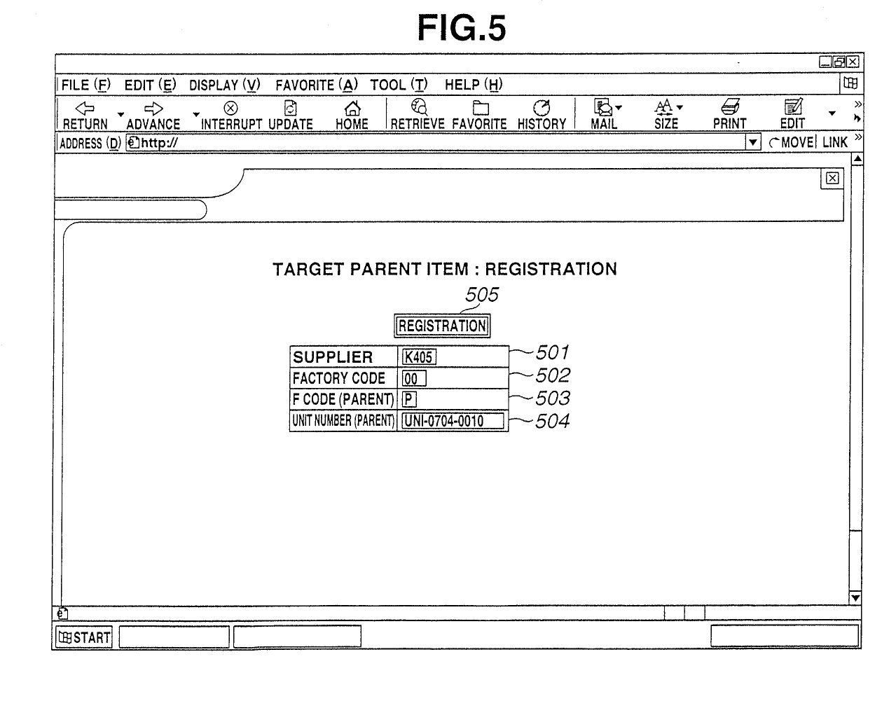

This is a picture frame for registering a number representing each unit to be ordered to the assembly maker. By selecting “1. registration of parent item” shown in FIG. 4 using an input device, such as a mouse, a keyboard or the like, a picture frame shown in FIG. 5 is displayed. In the picture frame shown in FIG. 5, by assigning a code 501 (supplier code) of an assembly maker, serving as a destination of request, a supplier-factory code 502, an F code (for identifying whether the concerned number represents a product or a component) 503, and the number of a unit to be requested (unit number) 504, and selecting a registration button 505, registration is completed.

(Reference/Change of a Parent Item)

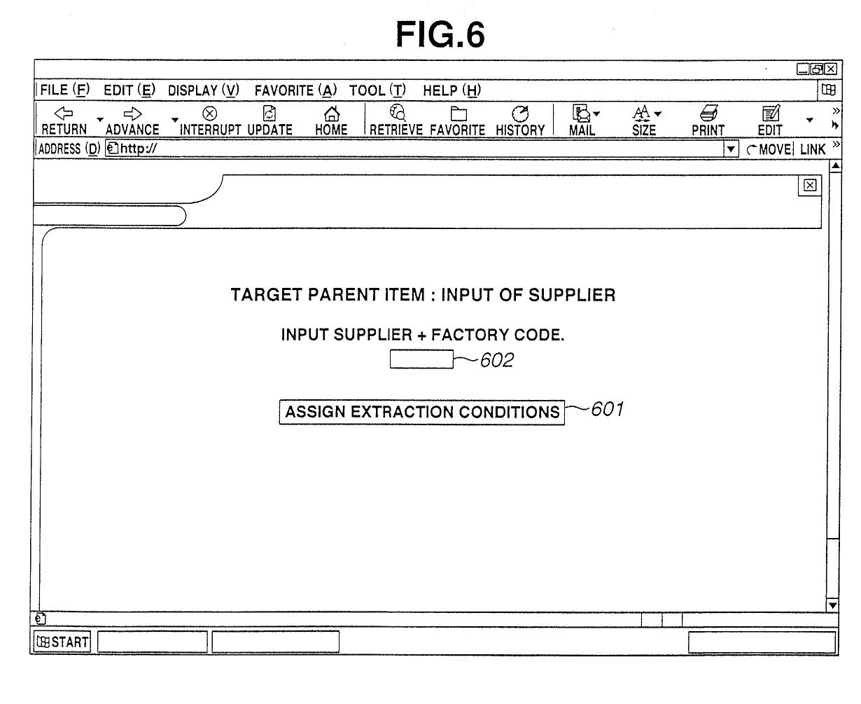

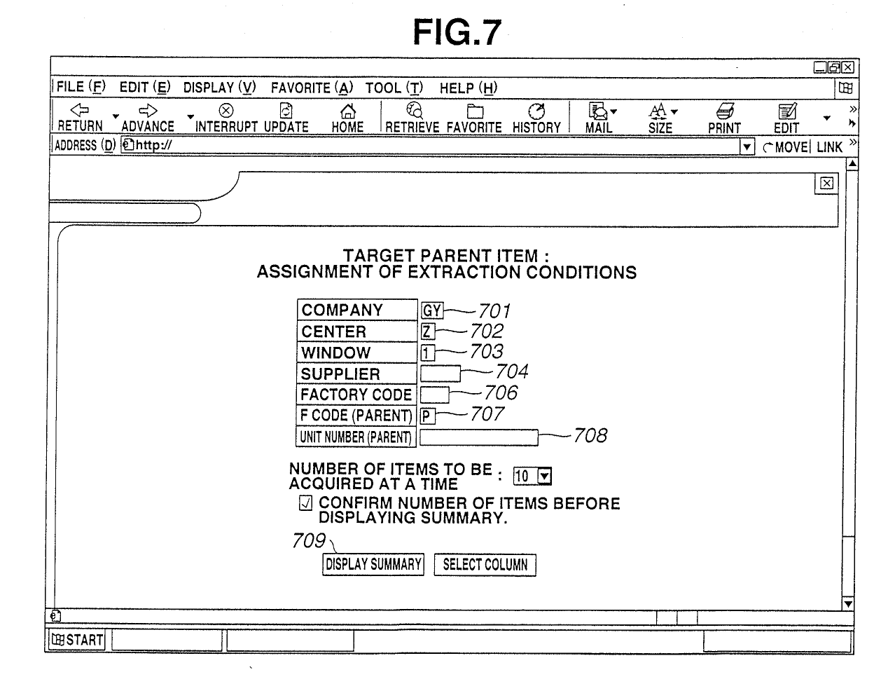

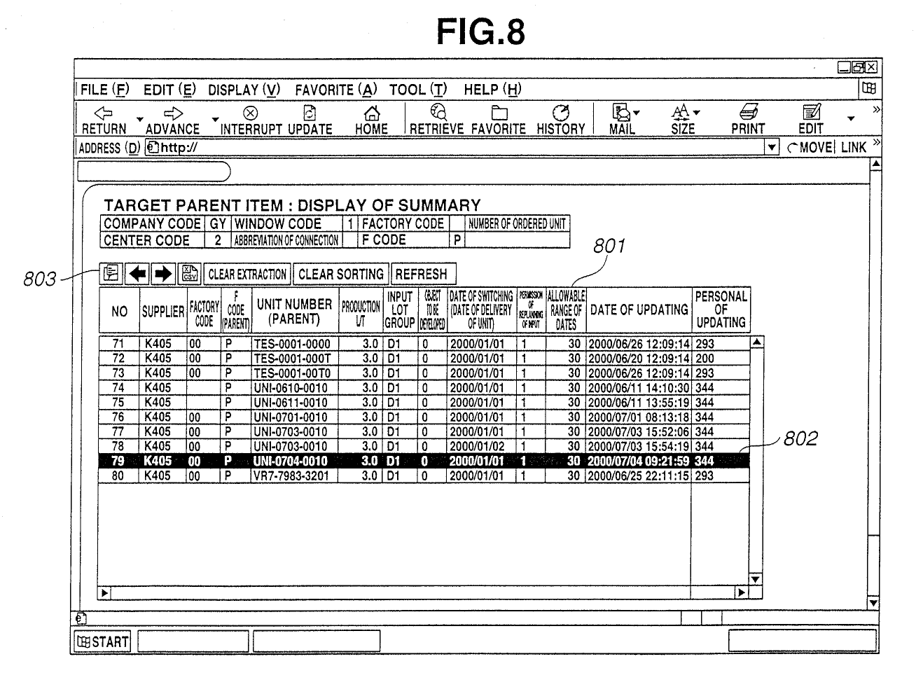

By selecting “2. reference/change of parent item” shown in FIG. 4 using the input device, a picture frame shown in FIG. 6 is displayed. In this picture frame, by inputting a supplier code+a supplier-factory code (6-digit code) 602, and selecting an extraction-condition assigning button 601, a picture frame shown in FIG. 7 is displayed. In the picture frame shown in FIG. 7, by inputting extraction conditions 701-708, and selecting a summary-display button 709, data coinciding with the extraction conditions is subjected to summary display 801 as shown in FIG. 8. In FIG. 7, the extraction conditions include a company (two-digit abbreviation) 701, a center (one-digit abbreviation) 702, a connection (four-digit abbreviation) 704, a unit number (parent) (15-digit unit number representing a unit) 708, and the like.

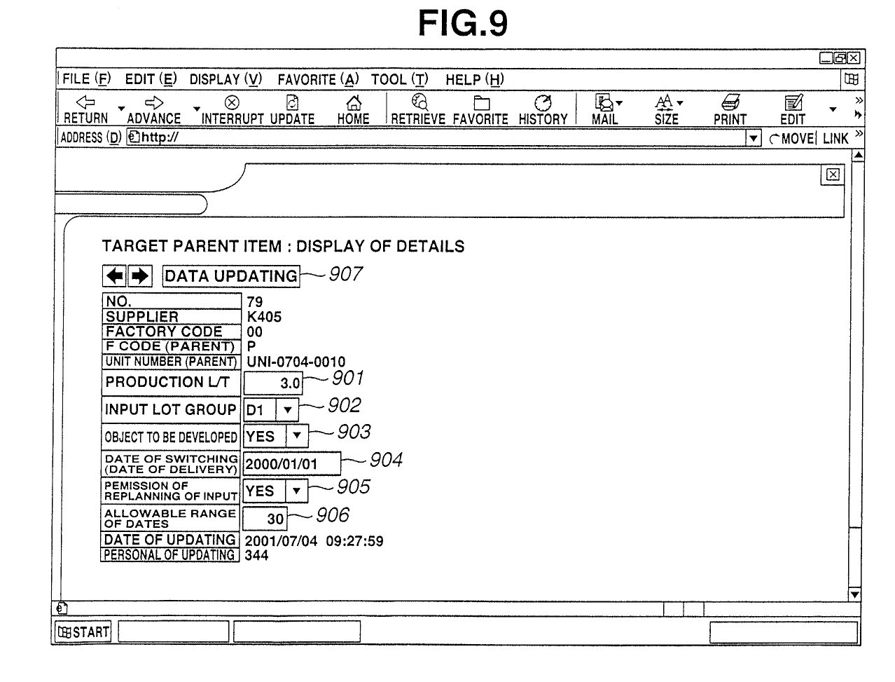

In FIG. 8, when changing data, by selecting data to be changed by an instruction through the input device (a portion subjected to reversal display in FIG. 8), and selecting a detail-display button 803, a picture frame shown in FIG. 9 is displayed, and by inputting portions to be changed 901-906, and selecting an updating button 907, a change is performed. In FIG. 9, items which can be changed are a production L/T (lead time for manufacturing units) 901, an input lot group (the size of a unit manufacturing lot) 902, and the like.

(Registration of a Child Item)

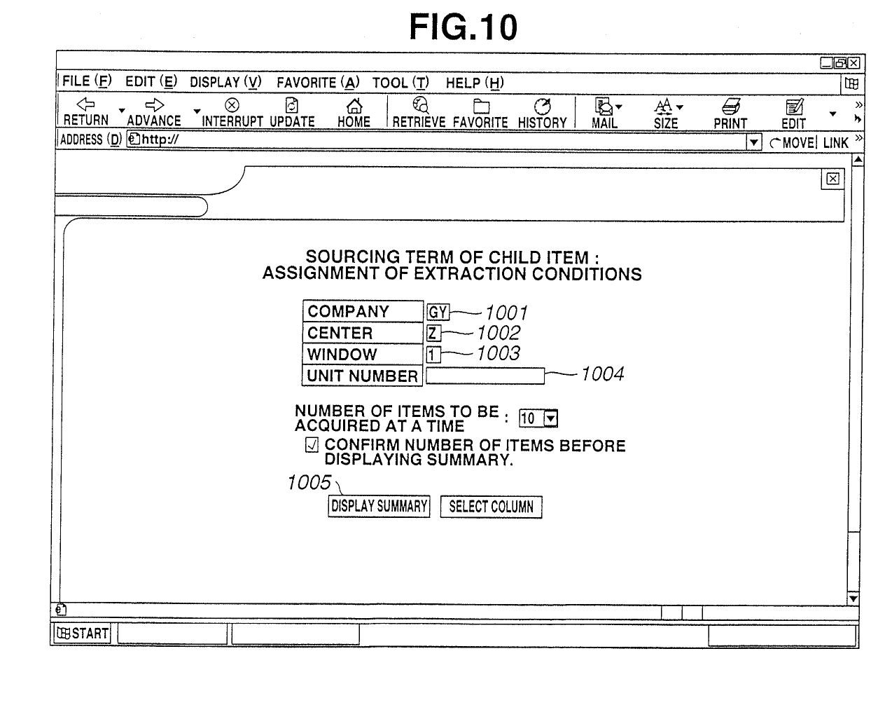

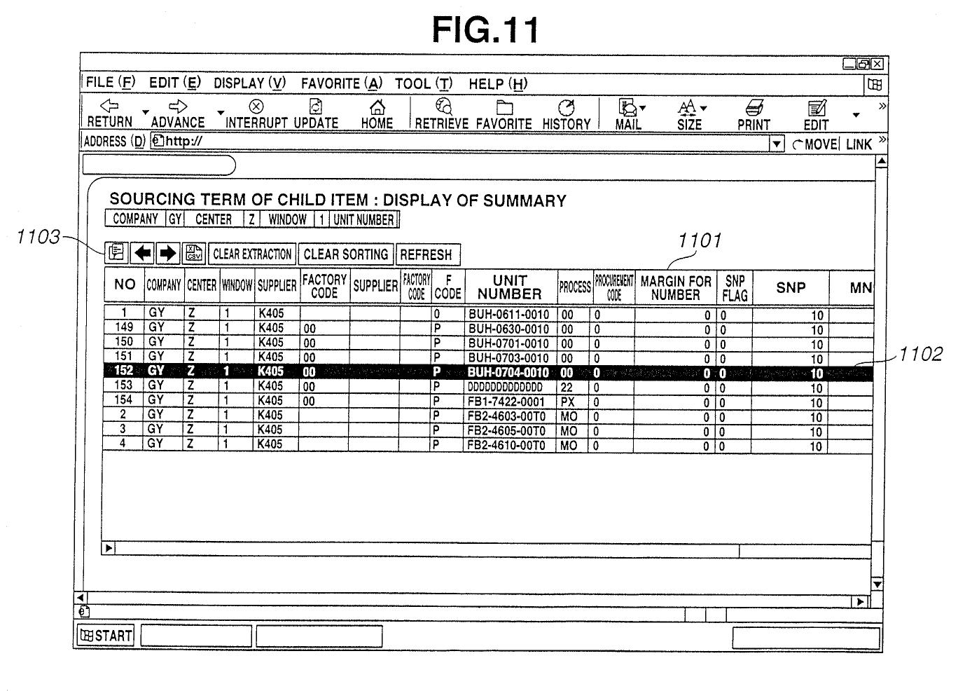

Conditions of an order for each component to be used for a unit or a product are registered. Many items are input as default items from respective master files. By inputting conditions of an order, a condition master file for forming order data is provided. By selecting “3. registration of child item” shown in FIG. 4, a picture frame shown in FIG. 10 is displayed. In the picture frame shown in FIG. 10, by inputting extraction conditions 1001-1004, and selecting a summary-display button 1005, a summary picture frame 1101 shown in FIG. 11 is displayed.

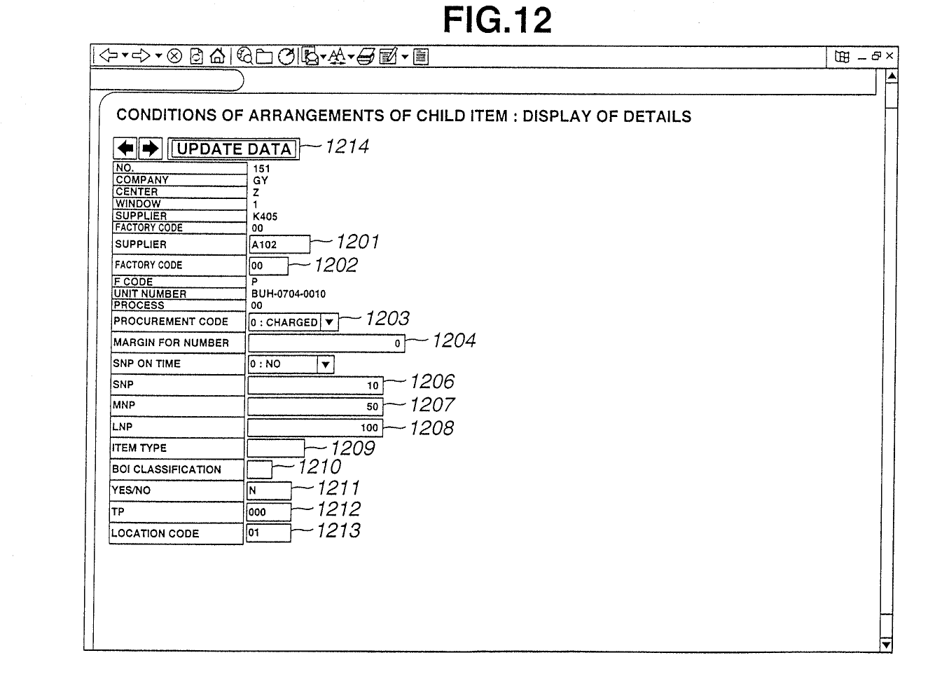

In the picture frame shown in FIG. 11, by selecting data to be changed (a portion subjected to reversal display 1102), and selecting a detail-display button 1103, a picture frame shown in FIG. 12 is displayed. By inputting necessary data 1201-1213, and selecting a data-updating button 1214, updating is completed. In FIG. 12, data that can be changed includes a supplier (four-digit abbreviation) 1201, a procurement code (a one-digit flag indicating whether or not the concerned item is to be ordered in the system) 1203, and the like.

(Input Plan of a Parent Item)

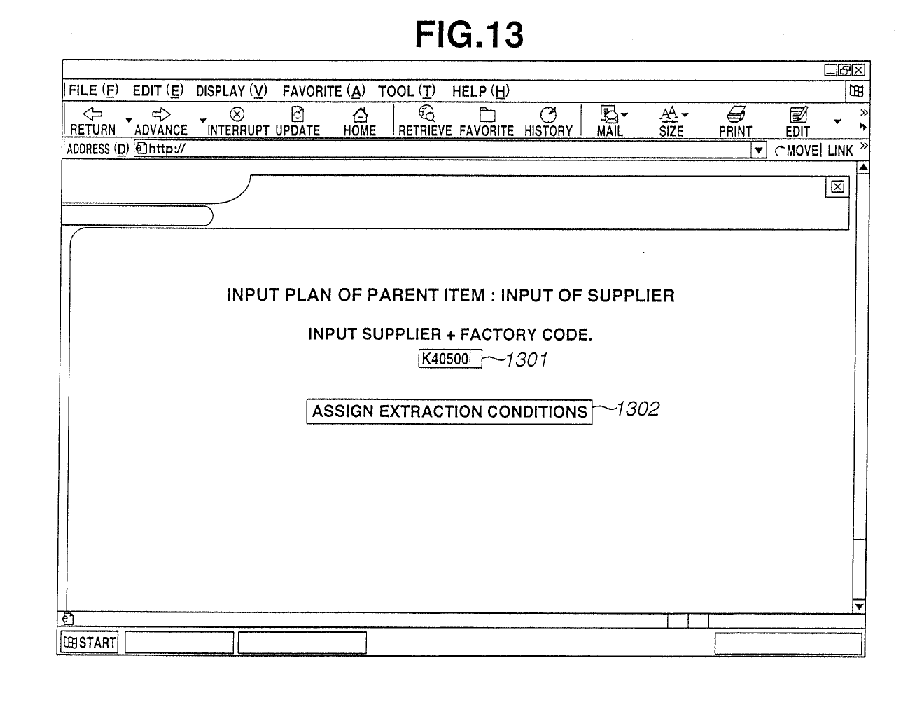

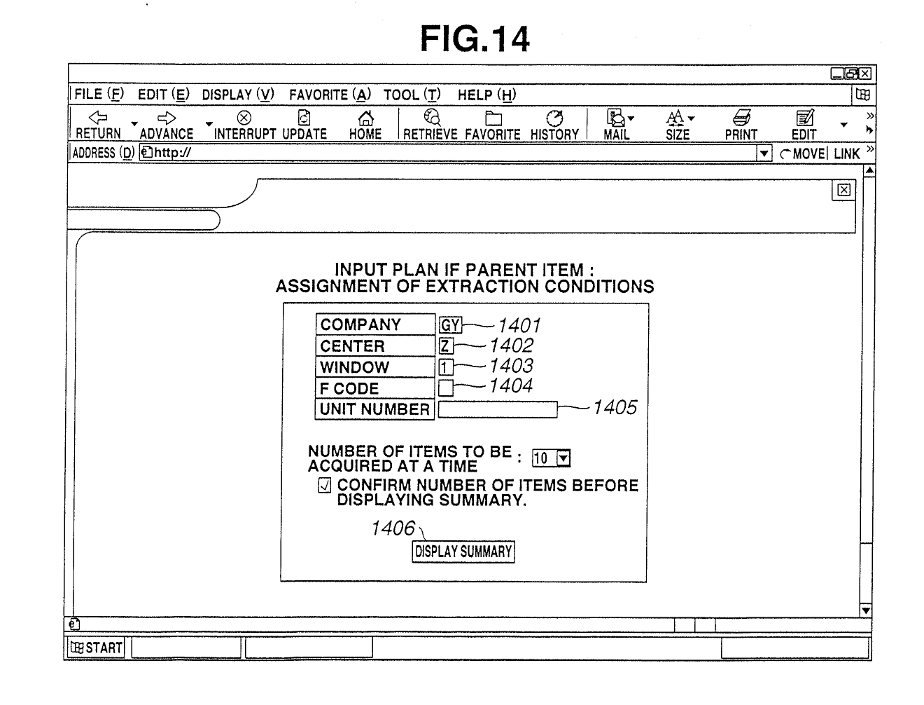

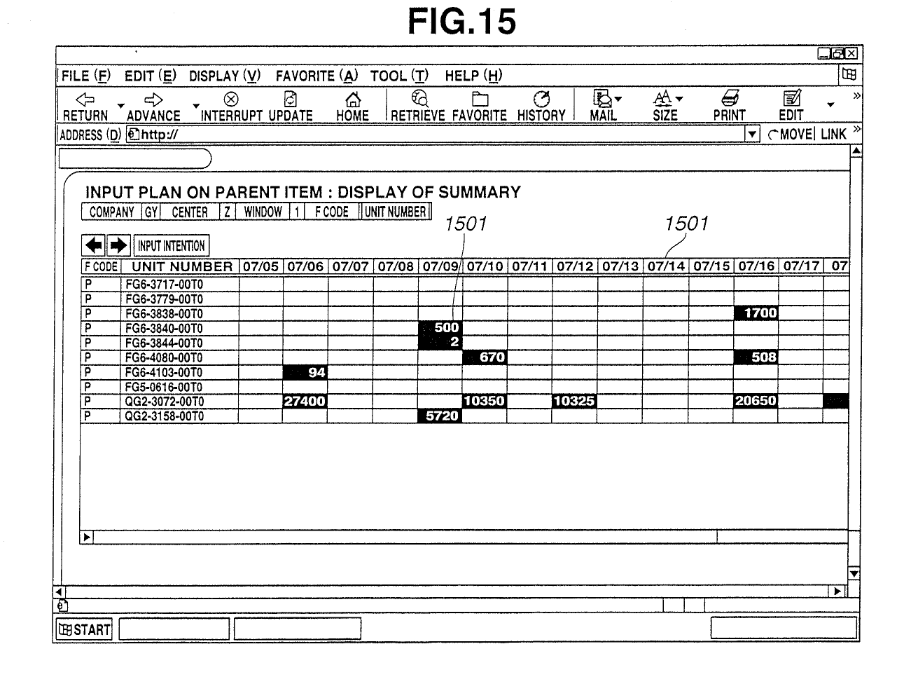

An input plan is automatically prepared based on production plans of the production centers 110-112. In order to arrange components so as to reflect the intension of the assembly maker, the automatically prepared plan is referred to/changed. By selecting “4. input plan of parent item” shown in FIG. 4, a picture frame shown in FIG. 13 is displayed. In the picture frame shown in FIG. 13, by inputting a supplier +a factory code 1301, and selecting an extraction-condition assigning button 1302, a picture frame shown in FIG. 14 is displayed. In the picture frame shown in FIG. 14, by inputting extraction conditions 1401-1405, and selecting a summary-display button 1406, a summary of the input plan of parent items 1501 shown in FIG. 15 is displayed. By reviewing this summary, the input plan of parent items can be confirmed.

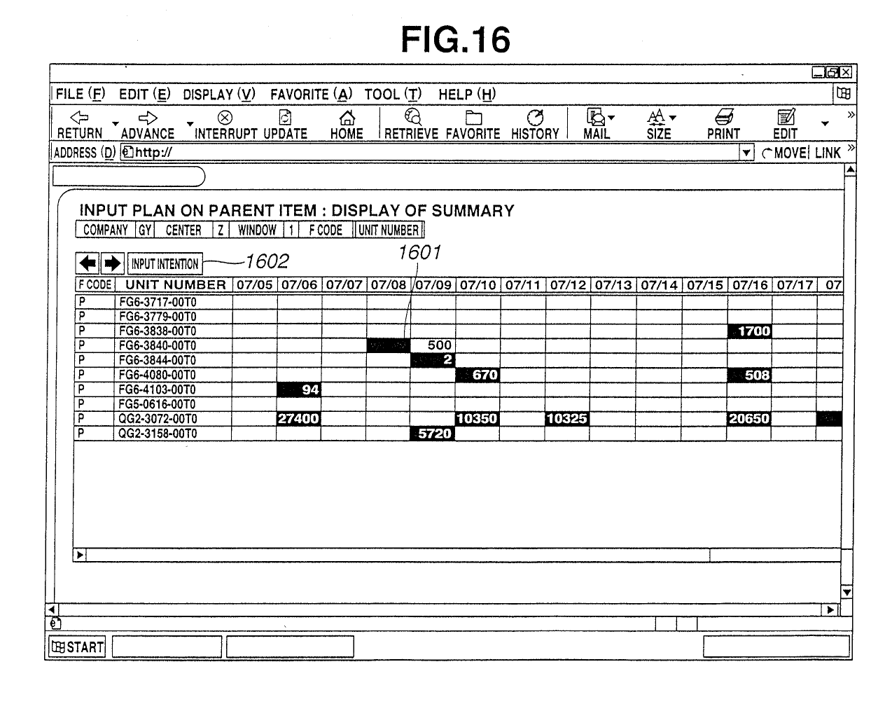

In the picture frame shown in FIG. 15, in order to reflect the intension of the assembly maker, by assigning a portion to be changed (1501 shown in FIG. 15) using the mouse or the like, assigning a portion of movement (1601 shown in FIG. 16), and selecting an intention-input button 1602, the assigned item can be changed.

(Reference/Change of a Price)

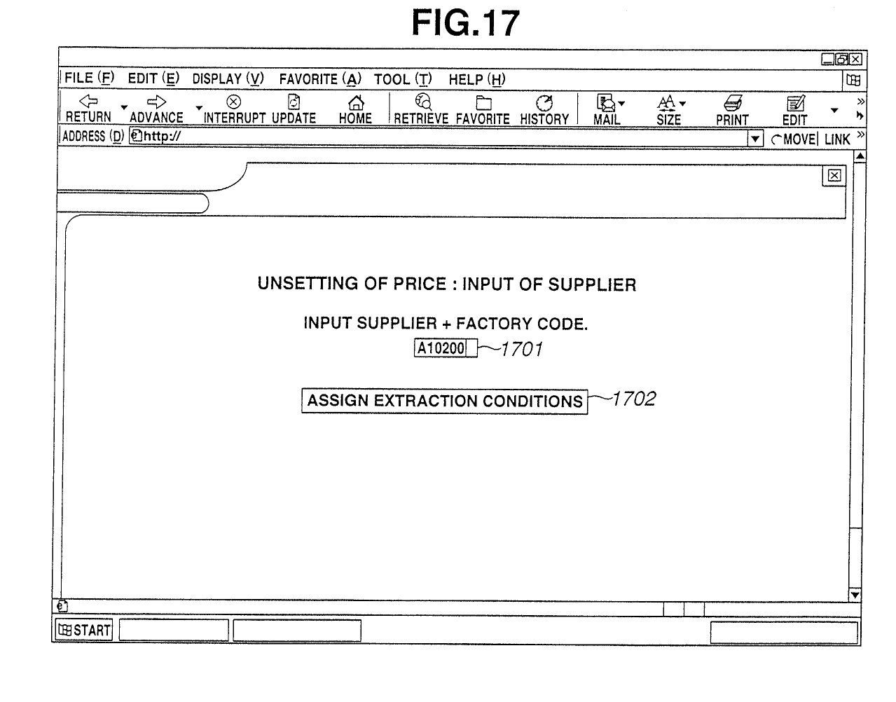

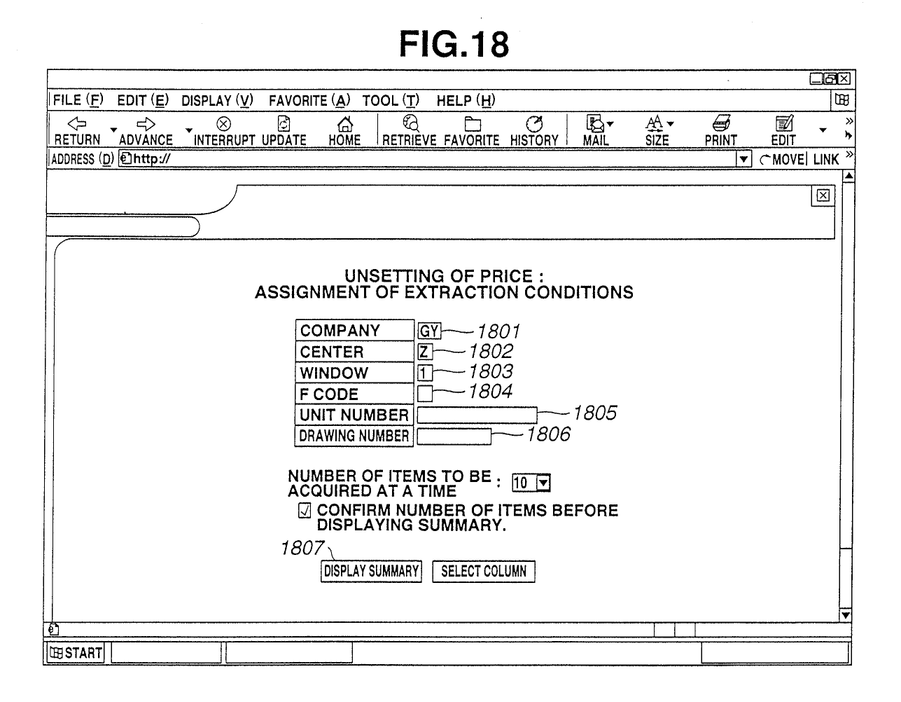

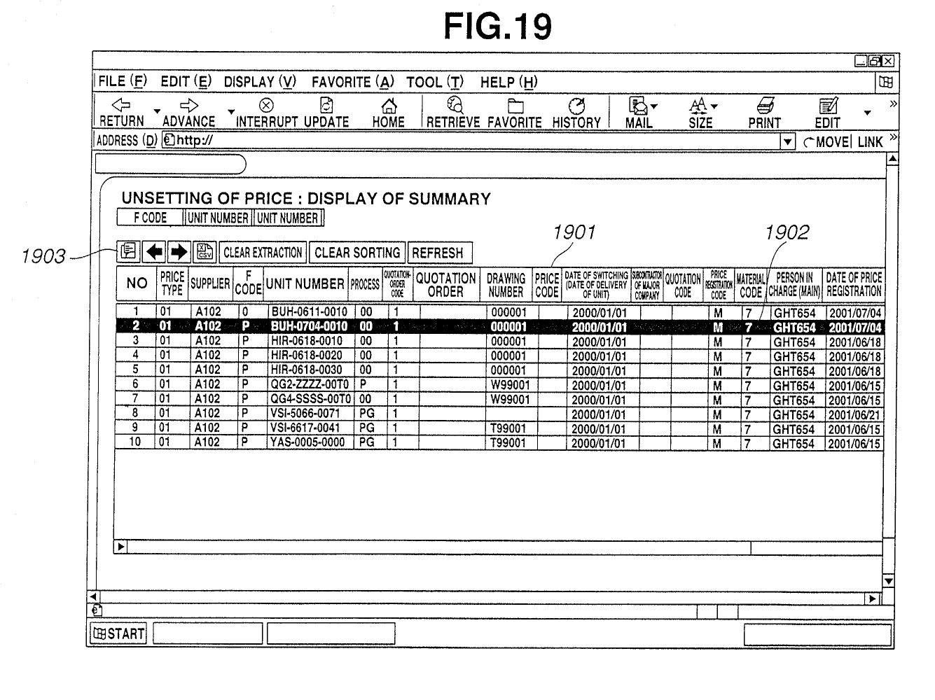

By referring to data of unsetting of a unit price for a unit number corresponding to a child component to be ordered, the component maker inputs a unit price. By selecting “5. reference/change of unit price” shown in FIG. 4, a picture frame shown in FIG. 17 is displayed. In the picture frame shown in FIG. 17, by inputting a supplier+a factory code 1701, and selecting an extraction-condition assigning button 1702, a picture frame shown in FIG. 18 is displayed. In the picture frame shown in FIG. 18, by inputting extraction conditions 1801-1806, and selecting a summary-display button 1807, a summary shown in FIG. 19 is displayed. In FIG. 18, extraction conditions include a unit number (a 15-digit number for a component) 1805, a drawing number (a 6-digit drawing number of the component) 1806, and the like.

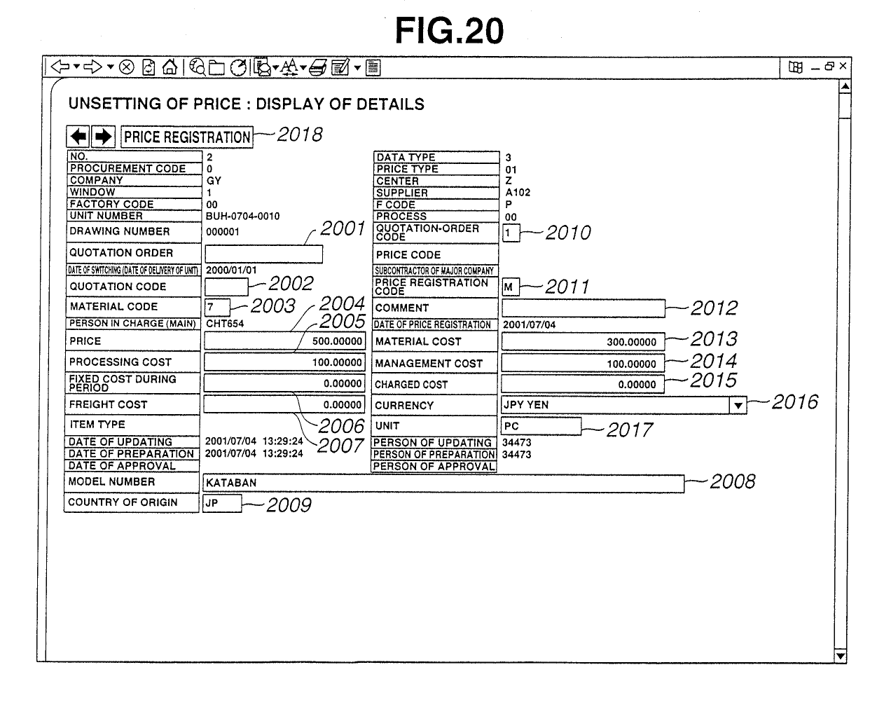

In FIG. 19, by selecting data to be changed (a portion subjected to reversal display 1902), and selecting a detail-display button 1903, a picture frame shown in FIG. 20 is displayed. In the picture frame shown in FIG. 20, by inputting data 2001-2017, and selecting a price-registration button 2018, data can be updated. Input data in FIG. 20 include a price (the sales price of each component of the connection) 2004, a material cost (one of contents of the price) 2013, a processing cost (one of contents of the price) 2005, currency (three-digit abbreviation) 2016, and the like.

(Approval of a Price)

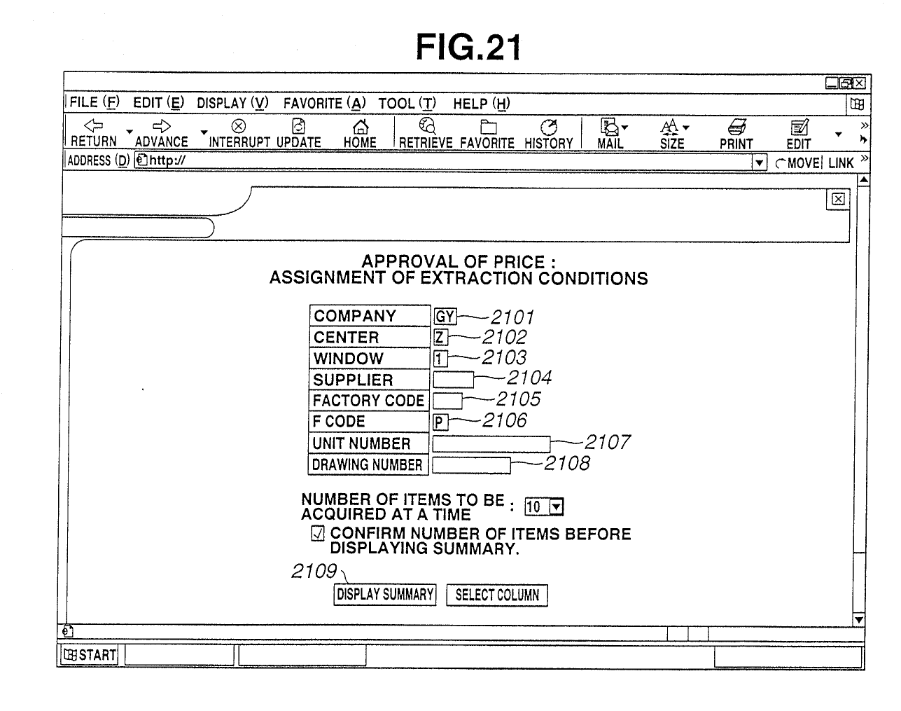

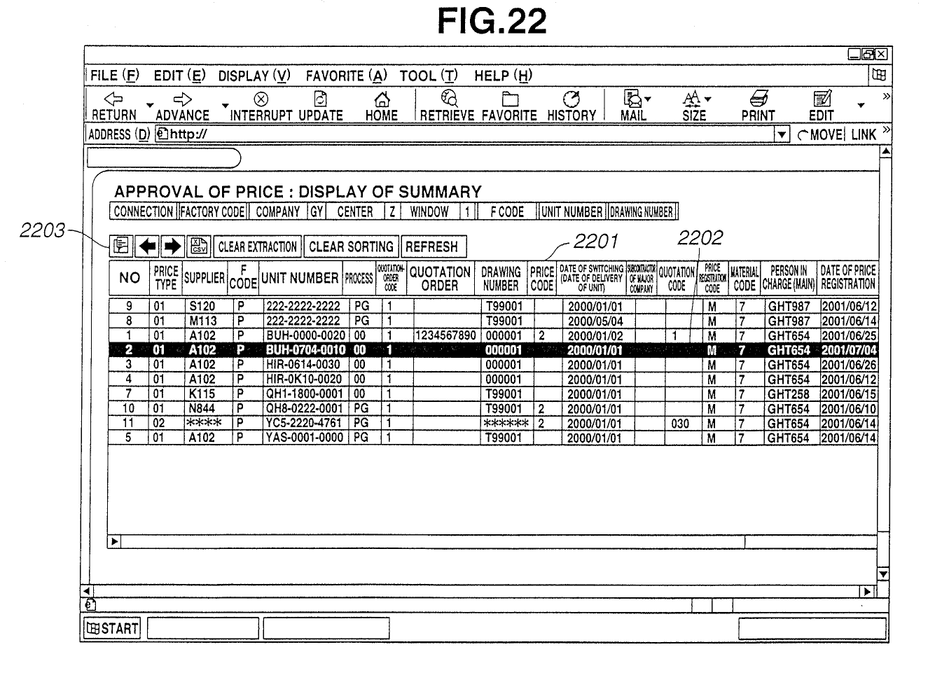

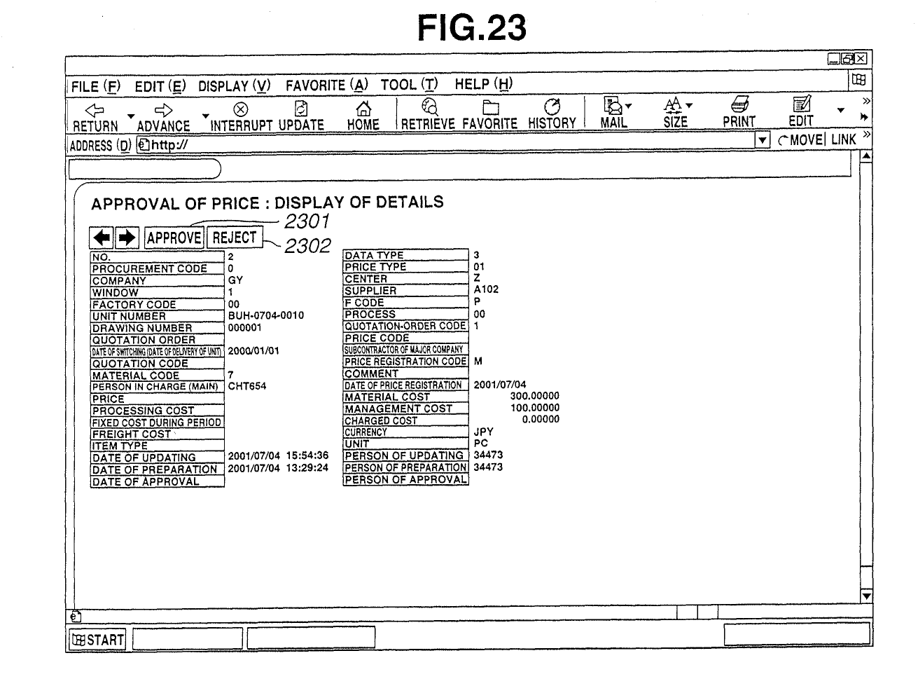

The price of each component input by the component maker is approved at each of the production centers 110-112. By selecting “6. approval of price” shown in FIG. 4, a picture frame shown in FIG. 21 is displayed. In FIG. 21, by inputting extraction conditions 2101-2108, and selecting a summary-display button 2109, a summary 2201 shown in FIG. 22 is displayed. In FIG. 22, by selecting data to be approved (a portion subjected to reversal display 2202), and selecting a detail-display button 2203, a picture frame shown in FIG. 23 is displayed. In FIG. 23, by confirming contents, and selecting an approval button 2301, the price is approved. By selecting a reject button 2302, the price is not approved. Whether or not a price has been approved can be seen by pointing “5. reference/change of unit price” shown in FIG. 4.

(PO status of a Parent Item)

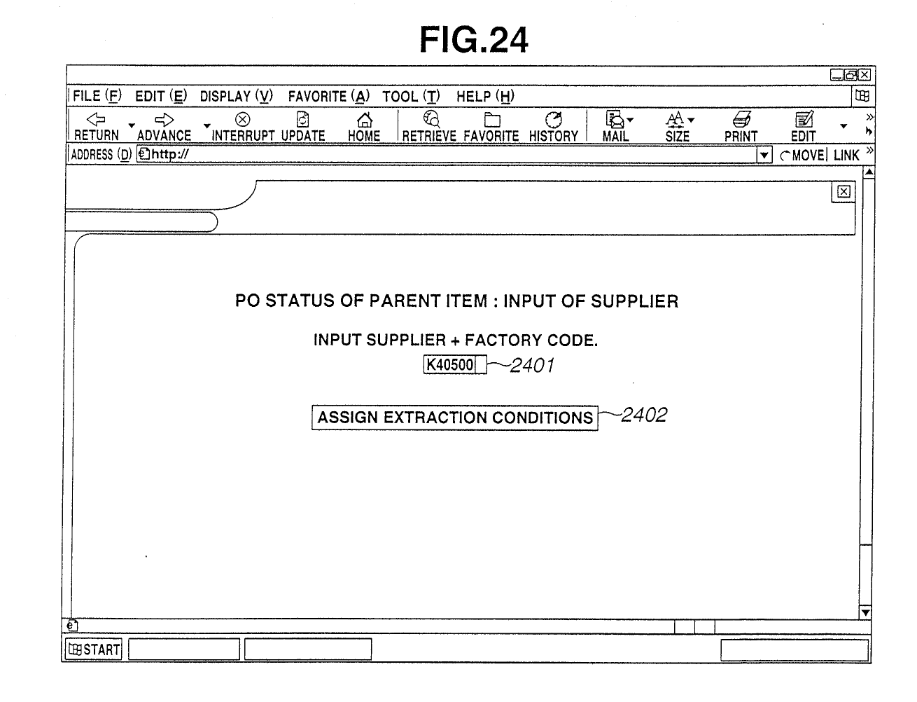

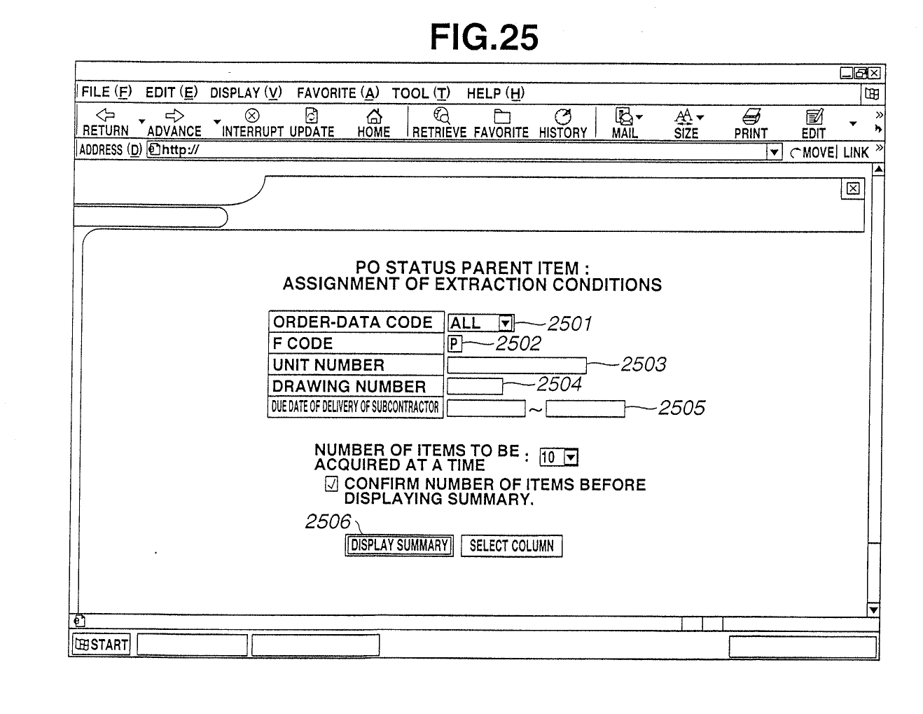

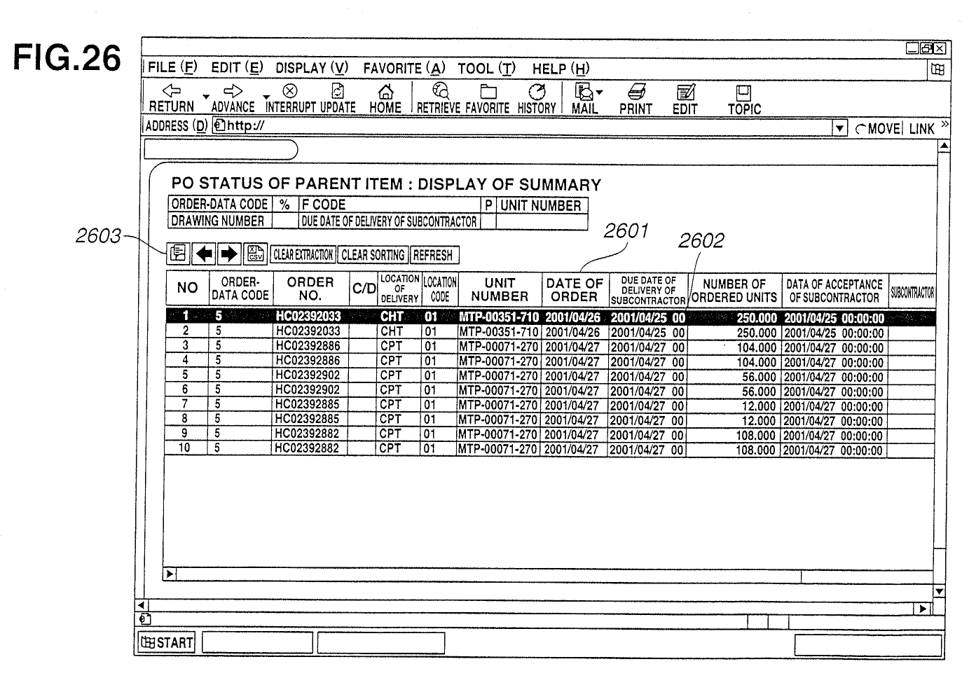

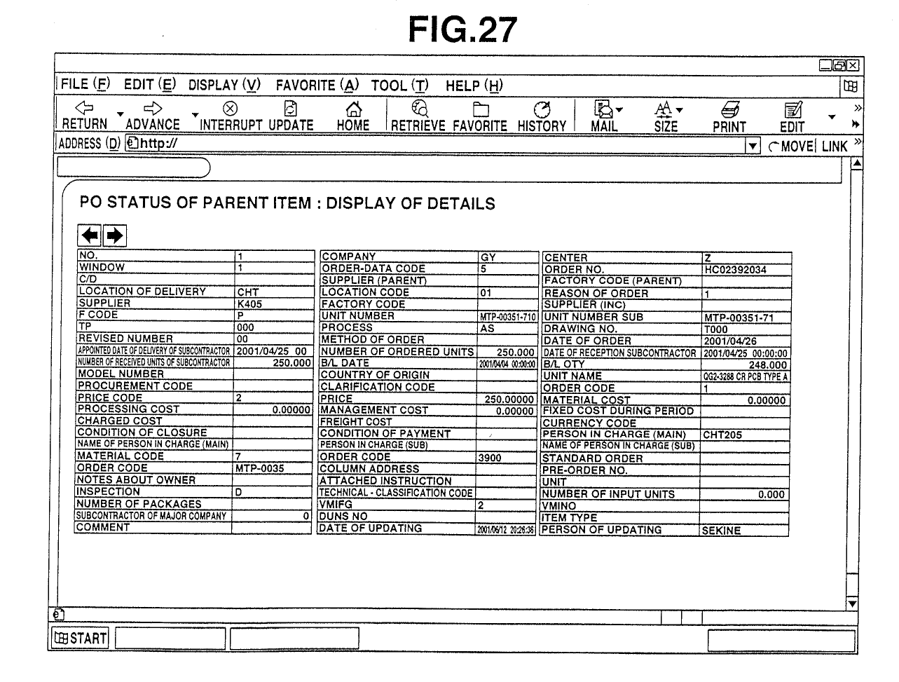

This is a picture frame for confirming order acceptance of a parent item. By selecting “7. P status of parent item” shown in FIG. 4, a picture frame shown in FIG. 24 is displayed. In the picture frame shown in FIG. 24, by inputting a supplier +a factory code 2401, and selecting an extraction-condition assigning button 2402, a picture frame shown in FIG. 25 is displayed. In FIG. 25, by inputting extraction conditions 2501-2505, and selecting a summary-display button 2506, a summary of PO status of parent items 2601 shown in FIG. 26 is displayed. In FIG. 25, extraction conditions include an order-data code (representing a status of order data of items to be ordered generated by the system) 2501, a unit number (comprising 15 digits) 2503, a drawing number (a 6-digit drawing number of a component) 2504, and the like. In FIG. 26, when intending to see detailed information, by selecting target data 2602, and selecting a detail-display button 2603, detailed information shown in FIG. 27 is displayed, so that detailed information can be confirmed.

(PO Status of a Child Item)

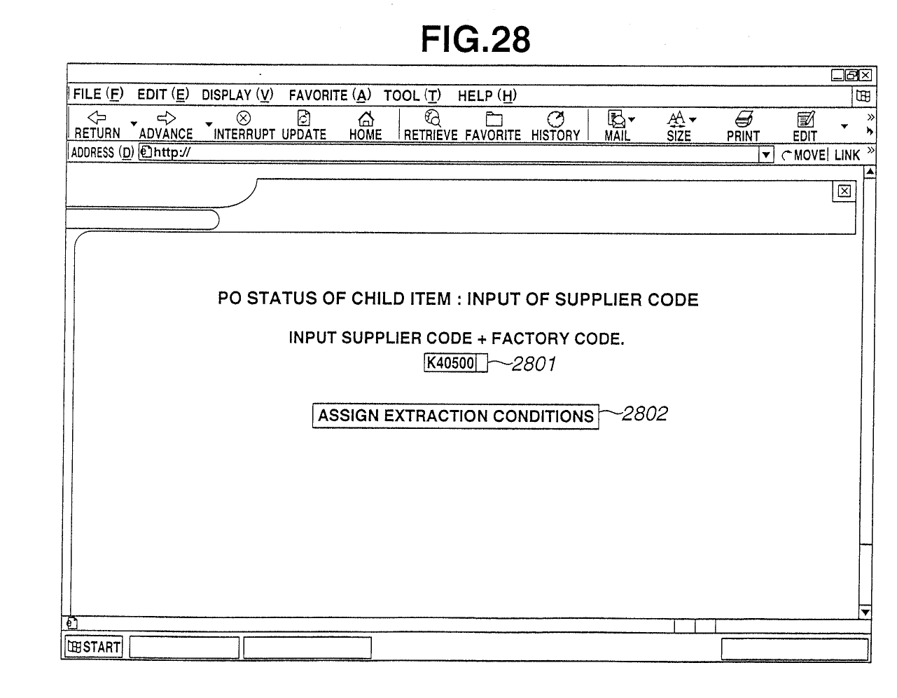

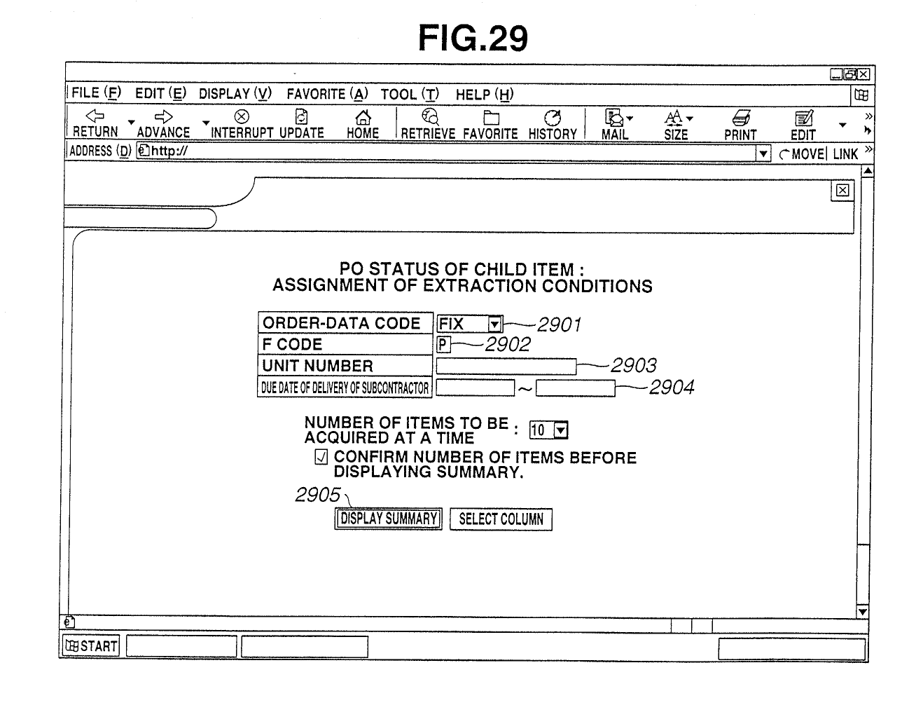

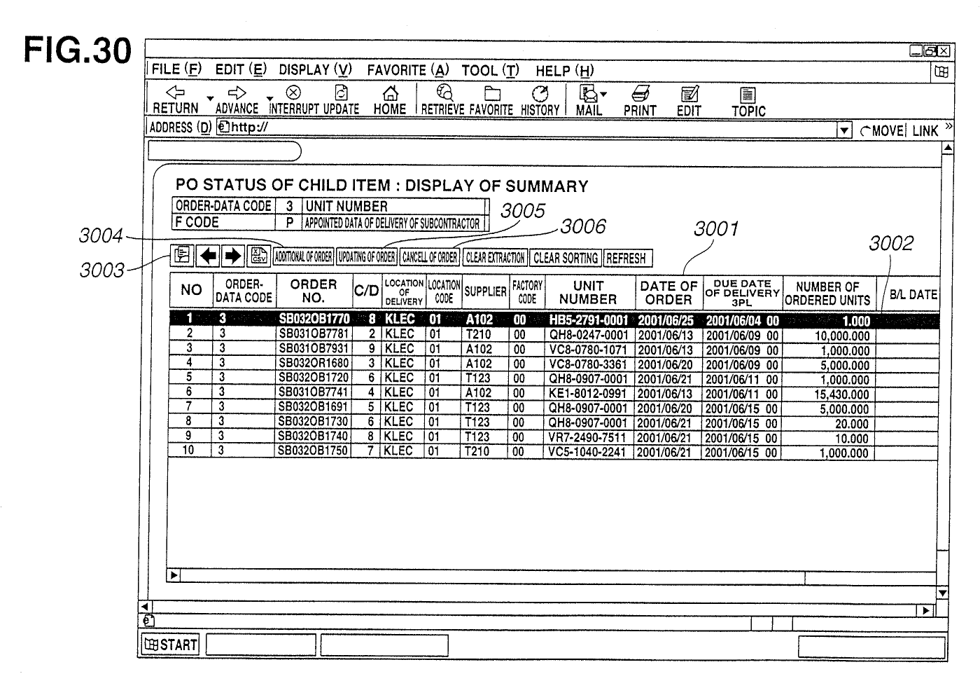

This is a picture frame for confirming PO status of a child item. By selecting “8. PO status of child item” shown in FIG. 4, a picture frame shown in FIG. 28 is displayed. In the picture frame shown in FIG. 28, by inputting a supplier+a factory code 2801, and selecting an extraction-condition assigning button 2802, a picture frame shown in FIG. 29 is displayed. In FIG. 29, by inputting extraction conditions 2901-2904, and selecting a summary-display button 2905, a summary of PO status of child items 3001 shown in FIG. 30 is displayed. In FIG. 29, extraction conditions include an order-data code (representing a status of order data of items generated by the system) 2901, a unit number (comprising 15 digits) 2903, and the like.

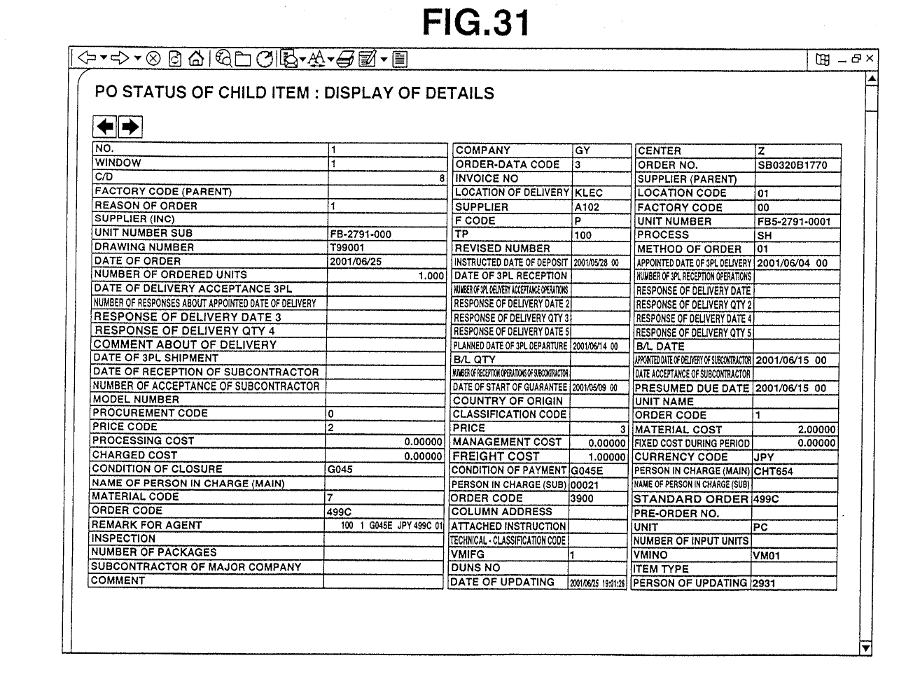

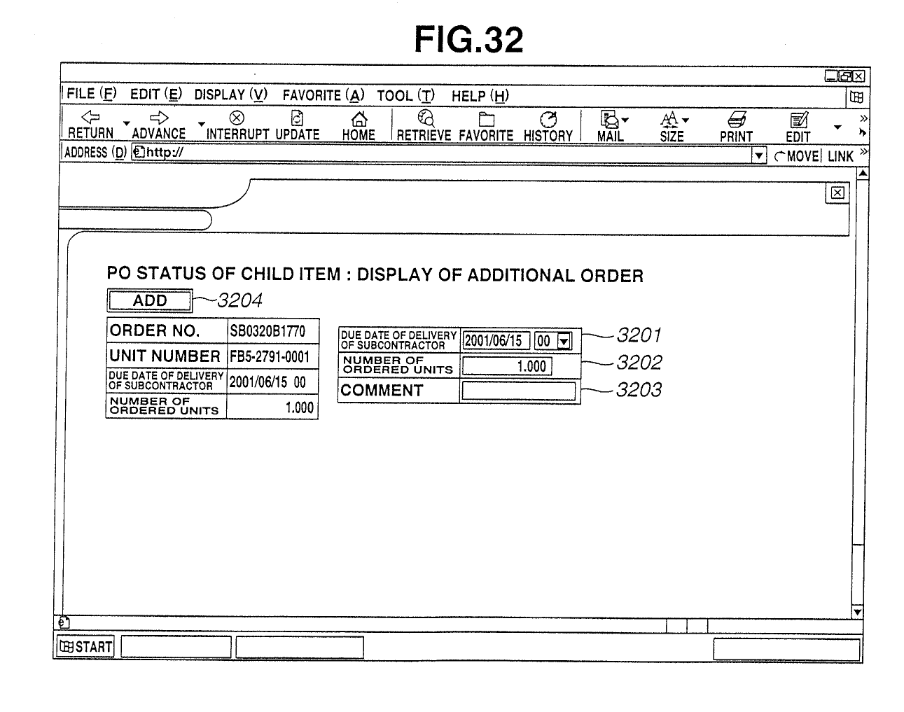

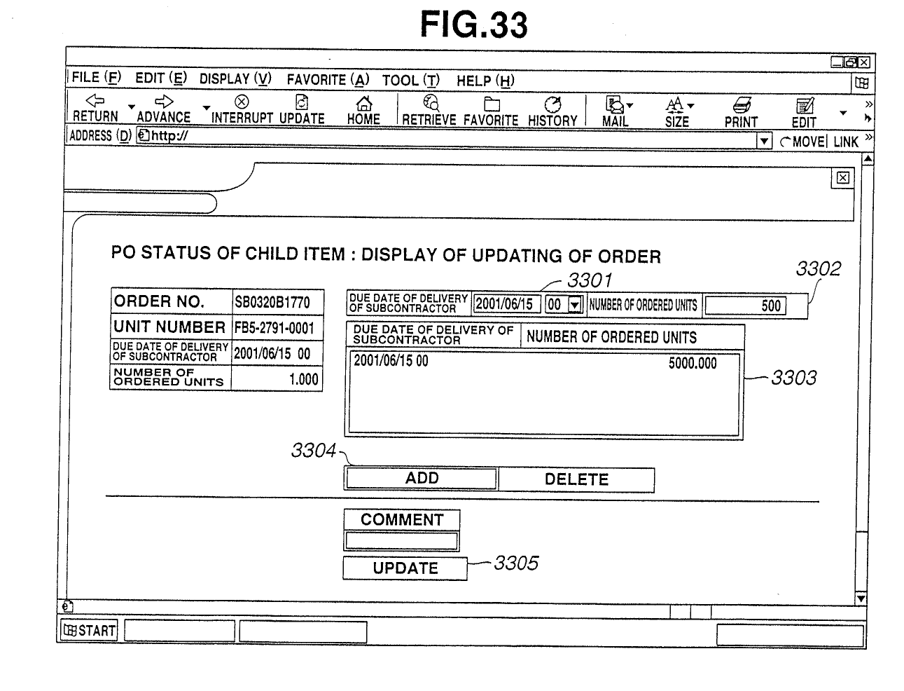

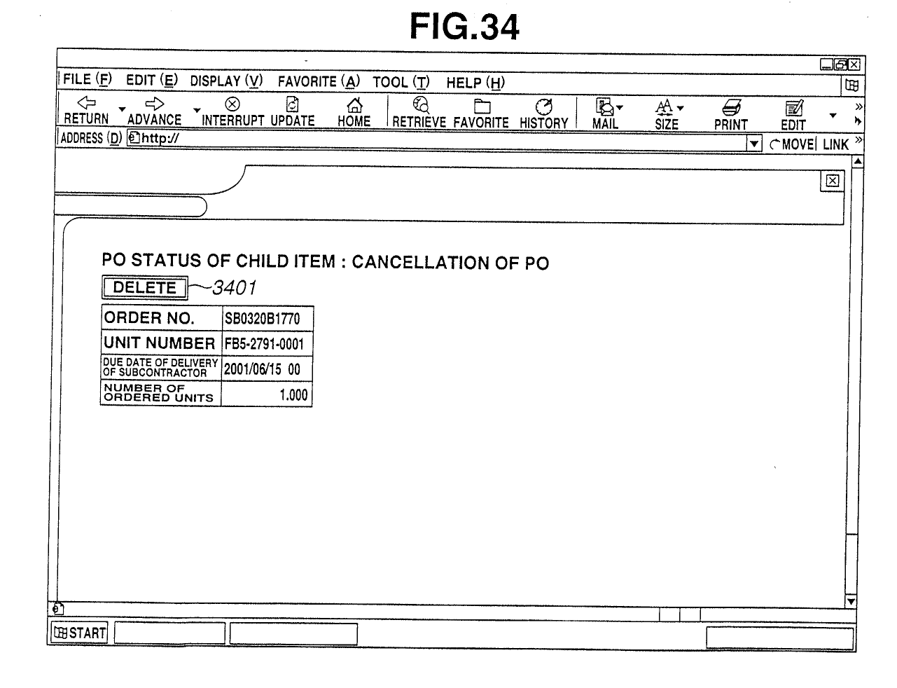

In FIG. 30, when intending to see detailed information, by selecting target data 3002, and selecting a detail-display button 3003, detailed information shown in FIG. 31 is displayed, so that detailed information can be confirmed. When intending to provide an additional order for a child item, by selecting target data 3002, and selecting, as seen in FIG. 32, an addition button 3004, an additional order for a child item is provided. When intending to update an order for a child item, by selecting target data 3002, and selecting an order updating button 3005, a picture frame shown in FIG. 33 is displayed. In FIG. 33, by inputting necessary data 3301-3303, and selecting an addition button 3304, an appointed date of delivery, or a quantity is changed, and by selecting an updating button 3305, updating of an order is performed. By pointing an order-cancel button 3006, a picture frame shown in FIG. 34 is displayed. By pointing a deletion button 3401, cancel of an order is performed.

The material procurement system 100 can access “1. registration of unit number”-“6. order acceptance/order of child item” shown in FIG. 4.

From the terminal of the assembly maker, “4. input plan of parent item” shown in FIG. 4 can be accessed, and “1. registration of parent item”-“3. registration of child item” only can be referred to.

The component maker can access “5. reference/change of price”, and can only refer to “8. PO status of child item”.

As described above, according to the above-described embodiment, it is possible to shorten a period from an order to delivery of components, and reduce inventories in process at the product developing/manufacturing company 200 and the assembly makers 141-142. In addition, the efficiency of management from an order to delivery of components is improved. Furthermore, production variations of components can be reduced in component makers.

Furthermore, it is possible to perform dealings across a border, minimize inventories in process at the product developing/manufacturing company 200 and the assembly makers 141-142 by depositing the inventories in a deposit warehouse as inventories of component makers, and perform unified management.

In addition, when changing a plan at a production center, information relating to a change in the required quantity of components is instantaneously transmitted to the concerned component maker, so that the lead time from order to delivery of a component can be minimized.

As described above, according to the present invention, it is possible to shorten the period from an order to delivery of components, and reduce inventories in process.

The individual components designated by blocks in the drawings are all well known in the information processing apparatus and method arts and their specific construction and operation are not critical to the operation or the best mode for carrying out the invention.

While the present invention has been described with respect to what is presently considered to be the preferred embodiment, it is to be understood that the invention is not limited to the disclosed embodiment. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An information processing apparatus comprising:
plan reference means for making a production plan in a state capable of being referred to from a unit maker;
reception means for receiving a production plan from the unit maker;
calculation means for obtaining an amount of demand of each type of component of a product based on the production plan from the unit maker and information relating to a configuration of the product; and
demand reference means for generating the obtained amount of demand into a state capable of being referenced by a component maker.

2. An information processing apparatus according to claim 1, wherein the amount of demand includes information relating to a date and a quantity of each type of component.

3. An information processing apparatus according to claim 1, further comprising destination reference means for generating information relating to a destination of delivery of each type of component into a state capable of being referenced by the component maker.

4. An information processing apparatus comprising:
reference means for referring to demand information from a client;
specifying means for specifying delivery place different from the client of each type of component produced based on the demand information;
confirmation means for confirming information relating to delivery acceptance of each type of component based on the demand information from the client; and
request means for requesting a cost for each type of component from the client, based on the confirmed information.

5. An information processing apparatus in a producer for delivering each type of assembled component to a client, said apparatus comprising:
plan means for providing a production plan of each type of assembled component based on information from the client;
transfer means for transferring information based on the production plan to the client;
payment means for paying a cost for each type of component from a component maker different from the client, to the client; and
request means for requesting a cost for each type of assembled component from the client.

6. An information processing method comprising:
a plan reference step of generating a production plan in a state capable of being referred to from a unit maker;
a reception step of receiving a production plan from the unit maker;
a calculation step of obtaining an amount of demand of each type of component of a product based on the production plan and information relating to a configuration of the product; and
a demand reference step of generating the obtained amount of demand into a state capable of being referenced by a component maker.

7. An information processing method according to claim 6, wherein the amount of demand includes information relating to a date and a quantity of each type of component.

8. An information processing method according to claim 6, further comprising destination reference step of generating information relating to a destination of delivery of each type of component into a state capable of being referenced by the component maker.

9. An information processing method comprising:
a reference step of referring to demand information from a client;
a specifying step of specifying delivery place different from the client of each type of component produced based on the demand information;
a confirmation step of confirming information relating to delivery acceptance of each type of component based on the demand information from the client; and
a request step of requesting a cost for each type of component from the client, based on the confirmed information.

10. An information processing method in a producer for delivering each type of assembled component to a client, said method comprising:
a plan step of providing a production plan of each type of assembled component based on information from the client;
a transfer step of transferring information based on the production plan to the client;
a payment step of paying a cost for each type of component from a component maker different from the client, to the client; and
a request step of requesting a cost for each type of assembled component from the client.

11. An information processing apparatus sharing information relating to production in a product manufacturer, an assembly manufacturer and a component manufacturer, said apparatus comprising:
summary display means for displaying a summary of an input plan of assembled components in the product manufacturer;
change means for instructing a change of the input plan displayed on said summary display means; and
order-information display means for displaying information relating to order of components including components to be used in the assembled components on a terminal of the component manufacturer, based on the change.

12. An information processing apparatus according to claim 11, wherein the change is instructed from a terminal of the product manufacturer or the assembly manufacturer.

13. An information processing apparatus according to claim 11, wherein the summary of the input plan displayed on said summary display means is assigned by inputting a code indicating the assembly manufacturer.

14. An information processing apparatus according to claim 11, wherein the order information displayed on said order-information display means is assigned by inputting a code indicating the component manufacturer.

15. An information processing apparatus according to claim 11, further comprising order-addition means for providing an additional order of components, utilizing the order information displayed on said order-information display means.

16. An information processing method sharing information relating to production in a product manufacturer, an assembly manufacturer and a component manufacturer, said method comprising:
a summary display step of displaying a summary of an input plan of assembled components in the product manufacturer;
a change step of instructing a change of the input plan displayed in said summary display step; and
an order-information display step of displaying information relating to an order of components including components to be used in the assembled components on a terminal of the component manufacturer, based on the change.

17. An information processing method according to claim 16, wherein the change is instructed from a terminal of the product maker or the assembly manufacturer.

18. An information processing method according to claim 16, wherein the summary of the input plan displayed in said summary display step is assigned by inputting a code indicating the assembly manufacturer.

19. An information processing method according to claim 16, wherein the order information displayed in said order-information display step is assigned by inputting a code indicating the component manufacturer.

20. An information processing method according to claim 16, further comprising an order-addition step of providing an additional order of components, utilizing the order information displayed in said order-information display step.
